(19) United States
(12) Patent Application Publication
(10) Pub. No.: US 2019/0264662 A1
(43) Pub. Date: Aug. 29, 2019

(54) SYSTEM FOR STORING AND PRODUCING ELECTRICAL ENERGY BY GRAVITY USING LINEAR AND CONTINUOUS SOLID MASSES

(71) Applicant: MGH, Pérols (FR)

(72) Inventors: Jean-Michel Germa, Castelnau Le Lez (FR); Richard Perez, Delmar, NY (US); Marc Perez, Delmar, NY (US); Pierre Lagandre, Castelnau Le Lez (FR); Maxime Garbay, Montpellier (FR)

(21) Appl. No.: 16/320,039

(22) PCT Filed: Jul. 4, 2017
(86) PCT No.: PCT/FR2017/051813

§ 371 Date: Jan. 23, 2019

(30) Foreign Application Priority Data
Jul. 25, 2016 (FR) 1657085

(51) Int. Cl. F03G 3/00; F03B 17/02; F03G 7/04

(52) U.S. Cl. CPC F03G 3/00; F05B 2260/42; F03G 7/04; F03B 17/02

(57) ABSTRACT

A system for storing and producing electrical energy deployed in a volume of water delimited by a bottom, comprising a floating structure at the surface of the volume of water, at least one linear and continuous solid mass connected to the platform and movable between a high position and a low position, at least one device for driving one or more linear and continuous solid mass(es) between the high and low positions thereof; the linear and continuous solid mass comprises: an upper end positioned at the surface of the volume of water an opposite end which is free or connected to the bottom of the volume of water a portion lying on the bottom, also called a trailing portion, which is maximum when the linear and continuous solid mass is in the low position; a suspended portion, which is maximum from the moment that a trailing portion exists.

### BACKGROUND OF THE INVENTION

The present invention relates to the field of storage and releasing of electrical energy by immersing linear and continuous solid masses from a floating platform.

Such storage systems can be used, for instance, for storing the energy generated by renewable (wind, sun, photovoltaic, . . . ) sources or other (nuclear, . . . ) sources during “off-peak” times when the need for energy is lower than the produced and/or inexpensive energy, and for releasing same at times when the need for energy is higher than the produced and/or more expensive energy.

The patent application WO 2014/160522 is known in the prior art, which discloses a system for storing and releasing energy. Such system, deployed in a volume of water, includes a platform, at least ballast in the form of one weight, laid on the bottom of the volume of water, a hoisting system capable of moving said ballast between a first elevation position and a second elevation position, and a remote-controlled hooking device coupled to the hoisting system and configured for locating and coupling said at least one weight on the bottom of the volume of water, with said hoisting system selectively raising and lowering said at least one weight when coupled to the remote-controlled hooking device, from the first elevation position to the second elevation position, with said system storing and releasing energy when said at least one weight is moved between the first elevation position and the second elevation position.

Although the solution disclosed in the international patent application WO 2014/160522 makes it possible to provide a very flexible answer to needs for storing and releasing electrical energy, both for short cycles of a few hours and for long cycles of several weeks or even several months, it appears that some improvements can be brought to optimize the operation thereof and enhance some of its components, increase its competitiveness and solve some complex technical problems.

One of the challenges to be faced relates to the logistical management of the various weights used in this solution, which are hooked to and unhooked from hoisting ropes via mobile and autonomous hooks. Managing such ballast is a multiple task since it implies managing weights to be laid on the bottom of the water, then the storing thereof on the platform, and then managing the equipment provided for this purpose (the above-mentioned remote-controlled hooking device, the associated hooks, the ballast supporting synthetic cables, the deep-sea hoisting and anchoring system, mainly).

Another challenge lies in the off-peak hours for the production/consumption of electricity, during the ballast transition phases. For instance, the phase of transition of one weight, to the high position thereof, comprises the hooking thereof by the hooking device, and then the acceleration thereof when it starts sinking.

### SUMMARY OF THE INVENTION

In order to remedy such drawbacks, the invention relates to a system for storing and producing electrical energy deployed in a volume of water delimited by a bottom, with said system comprising:
a floating structure at the surface of the volume of water,
at least one linear and continuous solid mass (for example a line),
at least one device for driving one or more of said masses between the high and low positions thereof; characterized in that each one of said masses comprises:
an upper end positioned at the surface of the volume of water
an opposite end which is free or connected to the bottom of the volume of water
a portion lying on the bottom, also called a trailing portion, which is maximum when said mass is in the low position
a suspended portion, which is maximum from the moment that a trailing portion exists.

Said mass can take all intermediate positions between the high position and the low position thereof, with such intermediate positions being such that the length of the portion thereof which extends on the bottom (26) is smaller than that of the maximum trailing portion (Lt).

In each one of the positions wherein a portion of said mass is suspended between the bottom and the surface, the proper mass of the maximum suspended portion of said length mass (Ls) is thus substituted for that of one (or more) discrete and suspended weight(s), as in the document WO 2014/160522 incorporated by reference herein.

According to other advantageous characteristics of the invention, the system can additionally have one and/or the other of the following elements:
the floating structure comprises a device for storing said mass aboard,
the device for driving said mass is continuous and of the tracklayer, winch or windlass type and drives one or more of said mass(es) at the same time,
the system comprises detachable floating elements making it possible for said mass to float at the surface of the volume of water,
the floating elements are detachably attached to said mass and the platform comprises a space for storing such detachable floating elements when such elements are not attached to said mass,
each floating element is adapted to be attached to one or more of said masses at the same time,
one floating element, if filled with ballast material, can be converted into an additional ballast element of said mass, during the sinking of said mass, during the energy production phase,
said upper end of said mass is connected to a mooring buoy which keeps it at the surface of the volume of water and at a stationary position outside the floating structure,
when it comprises several said masses, the system also comprises means for spacing said masses from one another,
the system comprises means for spacing the lower ends of said masses and/or means for spacing the upper ends of said masses liable to form a floating element,
the floating structure is motorized according to a predetermined trajectory according to the direction of the electricity exporting cable connected to the floating structure and to the meteocean conditions (wind, currents, swell, etc.),
the electricity exporting cable is anchored or provided with an anchored buoy and the trajectory of the floating structure is curvilinear or has a different shape and is centered or not on the anchor or the anchored buoy of the electricity exporting cable,
the floating structure is motorized according to a predetermined trajectory according to the selected depth of the volume of water,
the floating structure is stationary or almost stationary, and the trailing length is right under the floating structure
the device for driving said mass between the high and low positions thereof comprises a variable and servo-controlled driving speed,
the whole system is driven by a wholly or partially automatic control device
said mass consists of:
   a large-sectioned cable having a diameter ranging from 50 to 600 mm, ideally made of metal,
   or a large-sectioned chain, having a nominal diameter (the diameter of the bar which is bent to form a link) ranging from 50 to 600 mm, ideally made of metal,
   or a cable/chain combination
   or one of the above three alternative solutions, in addition to which the weights are attached along said chain and/or said cable, at regular intervals or not, and detachably or not, with said weights being convertible into floating elements or not,
   or any assembly of unit elements specifically adapted to such application.

The invention also relates to a method for storing and producing electrical energy deployed in a volume of water delimited by a bottom, implemented by the above system, comprising:
a phase of energy storing, as potential energy, during which said mass is raised back up to the surface from the bottom of the water from a low position to a high position, using the driving device, with a fixed or variable driving speed
a phase of energy production during which said mass is lowered at least under the effect of its own weight from a high position to a low position.

The method and the system according to the invention are specially adapted to the storing of surplus electrical energy from the electric network and the restitution thereof, via one or more motor(s)/generator(s). Such motor(s)/generator(s) is/are coupled to the device for driving said masses and ensure the raising back up of said masses from a low position to a high position.

The masses driving device, which ensures the raising back up of said masses from a low position to a high position is coupled to one or more motor(s)/generator(s). In electricity storing mode, the motor(s) consume(s) the surplus electricity from the electric network so that the device driving said mass can raise the latter back up to the high position thereof. In electricity restitution mode, the sinking of said mass rotates the generator(s) via the driving device, which generator(s) produce(s) electricity which is released on the electric network and/or is at least partially stored in the floating structure, using an electricity storing device (batteries, for instance).

The continuity of electricity consumption (in storing mode) and production (in withdrawal mode) intrinsic to the system makes it possible to avoid off-peak times in the consumption/production of electricity during the deceleration/acceleration and unhooking/hooking phases of the weights in the state of the art disclosed in WO 2014/160522 and incorporated by reference herein.

### BRIEF DESCRIPTION OF THE DRAWINGS

The following paragraphs describe a line, as an illustrative but non restrictive example, for one embodiment of a linear and continuous solid mass.

The present invention will be better understood when reading the following description, while referring to a non restrictive exemplary embodiment illustrated by the appended drawings wherein:

FIGS. 1 to 3 schematically show a sectional view of the system for storing and producing electrical energy deployed in a volume of water delimited by a bottom, according to the invention, respectively in a low position, an intermediate position and a high position, according to a first alternative embodiment, wherein the upper portion of the line is stored aboard the floating structure

FIGS. 4 to 6 are views similar to those of FIGS. 1 to 3 of the system according to the invention, as per a second alternative embodiment wherein the upper portion of the line is stored outside the floating structure

FIG. 7 illustrates a top view of the system according to the invention, as per the second alternative embodiment, and shows the utilization of detachable buoys for storing the lines outside the floating structure

FIG. 8 illustrates a top view of the system according to the invention, as per the second alternative embodiment, and shows the optimization of the trajectory of the floating structure along an arc of a circle centered on an anchored buoy attached to an offshore power cable

FIGS. 9 to 11 illustrate a view of the system according to one embodiment wherein the floating structure is stationary or almost stationary and the line is unwound right below the floating structure.

### DETAILED DESCRIPTION

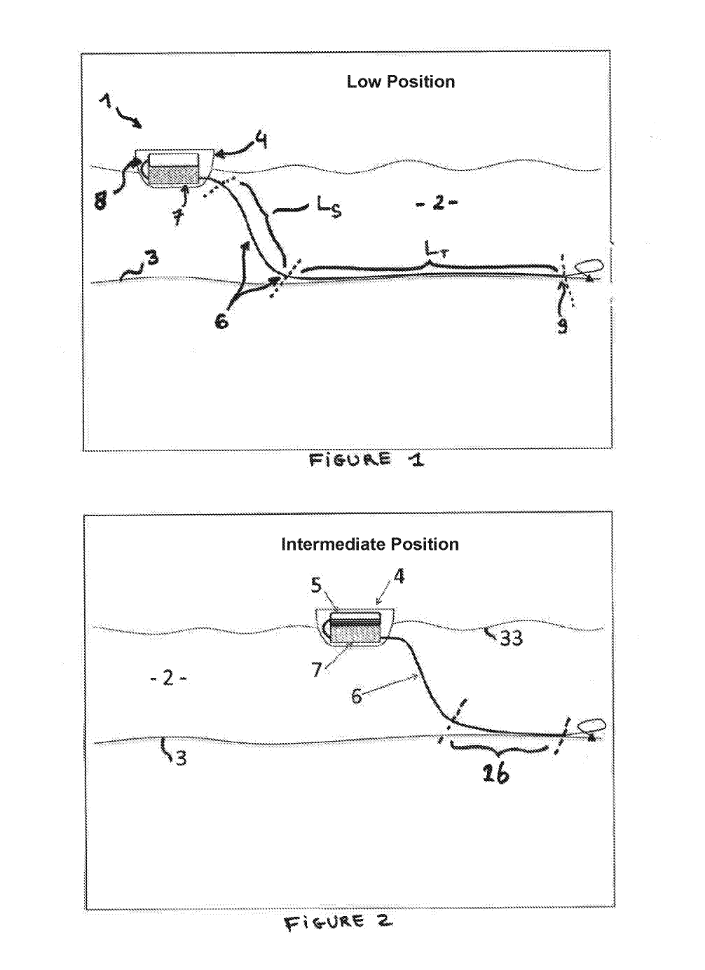

According to FIGS. 1 to 3, the invention relates to a system (1) for storing and producing electrical energy deployed in a volume of water (2) delimited by a bottom (3).

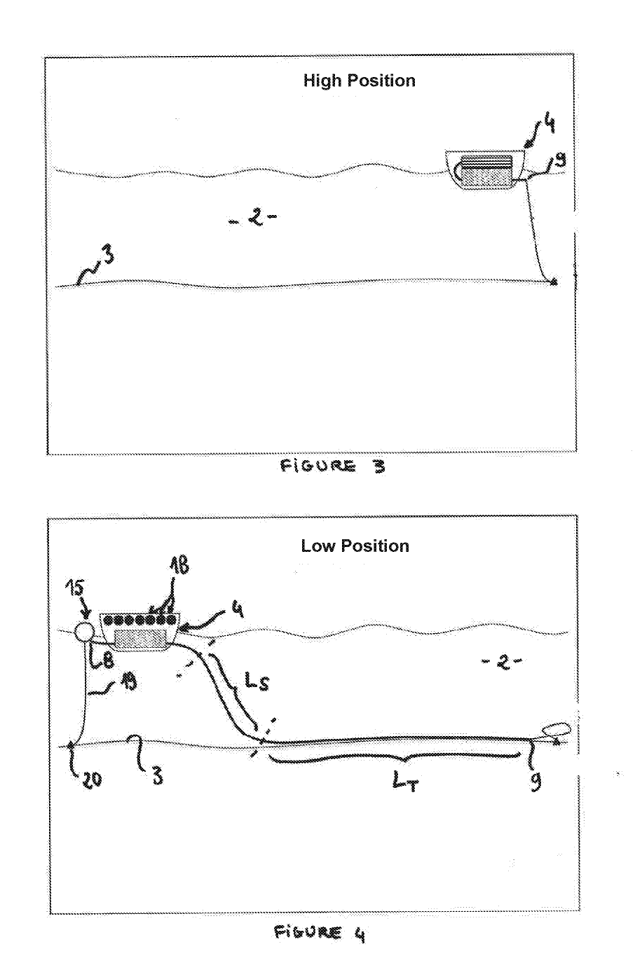

Such system comprises:
a floating structure (4) at the surface of the volume of water,
at least one linear and continuous solid mass 6 connected to the structure (4) and movable between a high position shown in FIG. 3 and a low position shown in FIG. 1, via various intermediate positions, one of which is shown in FIG. 2,
one device for driving (7) the element (6) between the high and low positions thereof.

In order to optimize the quantity of stored or produced energy without making the management of the mobile element(s) between the energy storage and production phases more complex, the mobile element(s) according to the invention is/are no longer ballast (weights or blocks), discrete (separate) and suspended between the bottom and the surface and to be unhooked/hooked, depending on the energy storage and production phases as mentioned as the prior art in the document WO 2014/160522.

Instead, such element (6) according to the invention has the shape of a linear and continuous solid mass (the line), which comprises:
an upper end (8) positioned at the surface of the volume of water
an opposite end (9) which is free or connected to the bottom of the volume of water
a portion lying on the bottom, also called a trailing portion, which is maximum (Lt) when the line is in the low position
a suspended portion, which is maximum (Ls) from the moment that a trailing portion exists,

The line may be made of materials denser than water, for instance metallic ones, having a length greater than the water depth, and the end of which, facing the floating structure, does not hold in height a mass or ballast like a block, as is the case in the prior art mentioned in WO 2014/160522 but lies on the bottom with a large portion of the line (the trailing portion) in most configurations of the system, except for the high position shown in FIG. 3.

As shown in FIG. 2, the line (6) may take any intermediate position, wherein its portion (16) which extends on the bottom is shorter than the maximum trailing portion (Lt).

Such system makes it possible to implement a system for storing and producing electrical energy which comprises:
a phase of energy storing during which the line 6 is raised back up to the surface from the bottom (3) of the water from a low position to a high position, using the driving device (7), with a fixed or variable driving speed provided by a motor/generator (at least partially) powered by the surplus electricity from the electric network or any other means
a phase of energy production during which the line (6) sinks, at least under the effect of its own weight, from a high position to a low position, with a fixed or variable driving speed.

More precisely, in electricity storage mode, the motors raise back up to the surface the lines lying at the bottom of the water. The force which applies to the motors then corresponds to the own mass of the line portion which is suspended, i.e. during the transition between the two elevation positions.

During the production phase, the generators are driven by the weight of the lines which sink while the floating structure ideally takes an optimum trajectory to place same on the bottom of the water (the ocean, the sea, a lake, . . . ).

As the generators should ideally operate at the same time, power variation can be obtained by varying the speed of the down and up motions of the lines, or by selecting bottoms at different depths, which makes it possible to modify the suspended length of the lines as well as the suspended own mass thereof.

For this purpose, the line can consist of:
a large-sectioned cable, having a diameter ranging from 50 to 600 mm, with a weight between about 1,000 and 240,000 T and having a length of about 30 km, ideally made of metal, specifically steel
or a large-sectioned chain having a nominal diameter (the diameter of the bar which is bent to form a link) ranging from 50 to 600 mm, having a weight between about 1,000 and 240,000 T and having a length of between about 21 and 35 km, ideally made of metal, specifically steel
or a cable/chain combination
or one of the above three alternative solutions, in addition to which weights are attached along said chain and/or said cable, at regular intervals or not, and detachably or not, with said weights being convertible into floating elements or not. The weights referred to can be “balls” positioned at regular intervals, and made of dense materials (for instance concrete and steel). They can be made integral with the line or be hooked/unhooked when and as the line is unwound/wound. In this case, a system for managing and storing the “balls” will be provided aboard the floating structure,
or any assembly of unit elements specifically adapted to such application.

Thus, the mass used in the physical formula E=MGH (where M is the mass, G the gravitational constant and H the mass travel height) is directly that of the line.

The line driving device is, according to the example shown in FIGS. 1 to 3, a traction or winding device of the tracklayer, winch or windlass type, or any other type, which can drive one or more line(s) at the same time.

In each one of the positions where a portion of the line is suspended between the bottom and the surface, the own weight of the maximum suspended portion of the line having a length (Ls) is thus substituted by one (or more) discrete and suspended weight(s) as mentioned in the prior art, in document WO 2014/160522.

As a matter of fact, if the total length of the line is a multiple N of the suspended length of the line on the considered seabed, the line can replace at least N−1 weights of the prior art by being simply moved up or down by the driving device, without requiring the hooking/unhooking of at least N−1 weights of the prior art, nor the management of the storing thereof aboard the floating structure.

In the example shown in FIGS. 1 to 3 and 9 to 11, the upper portion of the lines raised back up to the surface of the volume of water (33) is stored on the floating structure by being, for instance, wound about the associated driving device, or about a reel close thereto, or an associated pulley device, or “piled” aboard. FIGS. 1 to 3 and 9 to 11 show a system for storing the line aboard 5, with a driving device (7) being directly associated with a generator or a motor.

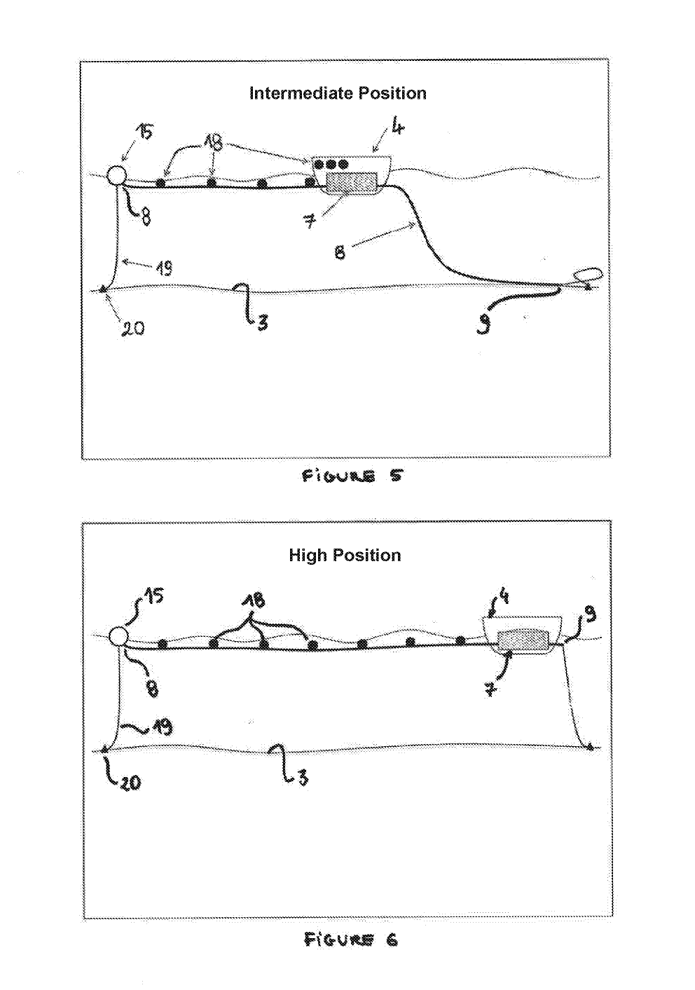

In the example shown in FIGS. 4 to 6, the upper portion of the line is stored outside the floating structure.

More precisely, as shown in FIG. 4, according to such alternative embodiment, the floating structure comprises, in a storage space provided for this purpose, floating elements or detachable buoys 18 for storing an upper portion of the line at the surface of the volume of water. Said upper end 8 of the line 6 comprises a buoy at the surface 15, which is anchored in a stationary position using a mooring line 19 ending in an anchor 20 lying on the bottom 3.

When raising the line back up (FIG. 5), the upper portion thereof raised back up to the surface of the volume of water is provided with detachable buoys 18 regularly spaced from each other when and as they are raised back up, while the floating structure is moved away from the anchored buoy and towards the mooring rope of the line (6), in the direction of deployment of such line (6). In an alternative embodiment of the system, the detachable buoys 18 are motorized and servo-controlled or not.

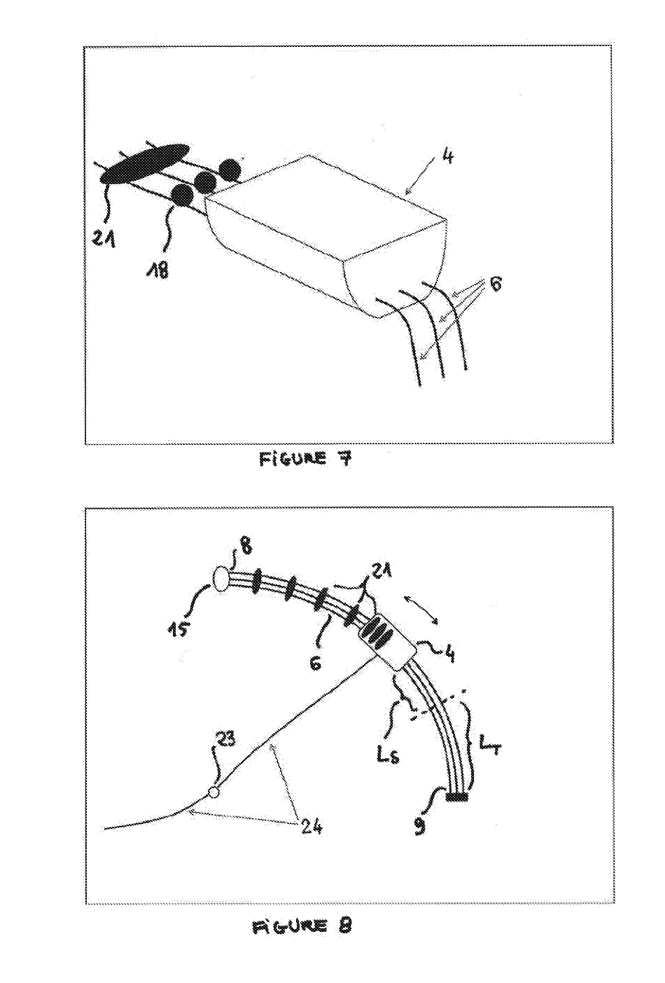

Once the line is totally raised back up to its high position (FIG. 6), it extends over its entire length at the surface, with a small portion remaining connected to the driving device, and with the major portion thereof extending between the floating structure and the mooring buoy (15).

In another embodiment for the production of a constant power, the line is not fully raised back up to its high position, and leaves a suspended portion of cable equal to the maximum suspended portion (Ls).

As illustrated in FIG. 7 which shows a top view of the system for storing the line outside the floating structure, wherein several lines are used, a detachable buoy (18) can be attached to a single line, or as shown by reference (21), have an elongated shape in the direction perpendicular to the parallel lines and be attached to several lines at the same time. It is then used as means for spacing the lines from one another.

According to an advantageous embodiment, the floating elements can be made integral with the line and be converted into ballast elements when the corresponding line portion must be immersed, into additional ballast element of the line, thus favoring the sinking of the line during the energy production phase. For this purpose, the air contained in the floating elements of one side of the structure can be emptied, and these can then be filled with a material denser than water, such as sand, on the platform, and immersed with the line of the side facing the platform to sink to the bottom.

The floating structure can either be stationary or moving.

As shown in FIG. 8, the trajectory of the mobile floating structure can define, between the anchoring line at the bottom of the lower end 9 of the lines (6) and the mooring buoy (15) of the upper end 8, an arc of circle centered on an anchored buoy (23) of an offshore electricity exporting cable (24) deployed towards the coast.

To vary the stored or produced power, the trajectory of the floating structure can also be optimized to lead the system to a predetermined place, having a depth adapted to the desired power.

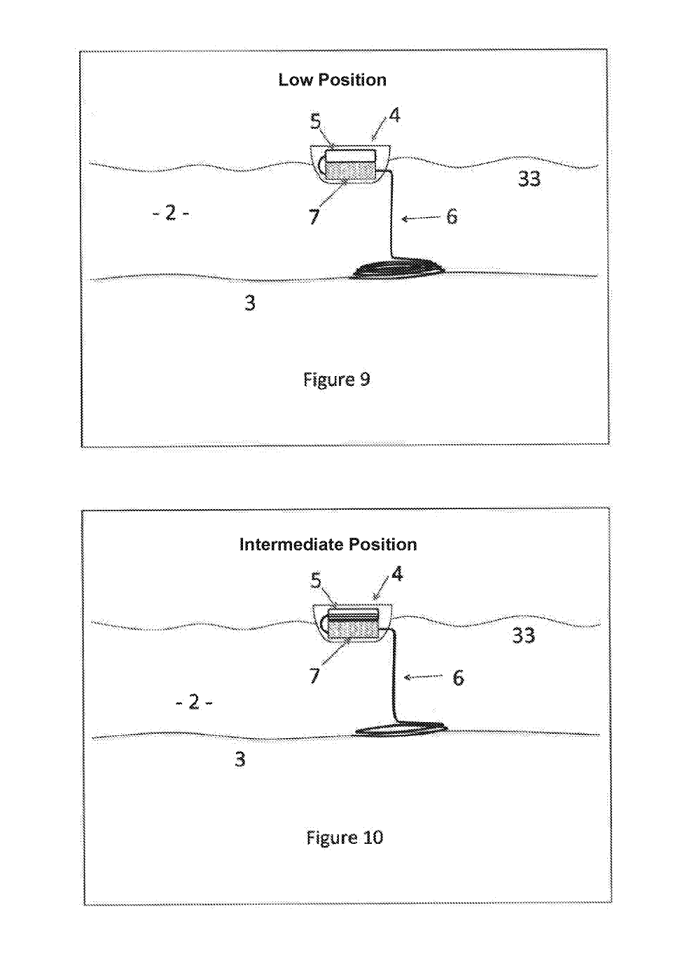

As shown in FIGS. 9 to 11, the line can be a metallic cable unwound right under a floating structure which is stationary. The line is thus laid “in turns” on the bottom of the volume of water (3).

In another embodiment, the line can be a chain, which is then “piled” on the bottom of the volume of water.

The floating structure can also move along a random trajectory within a perimeter defined by the elasticity of the ropes which link it to the seabed, under the stresses of the sea environment (the wind, swell, current, etc. . . . ). The line (6) is then laid on the bottom of the volume of water, according to a random trajectory too, which specifically depends on the trajectory of the floating structure and the stresses of the underwater environment.

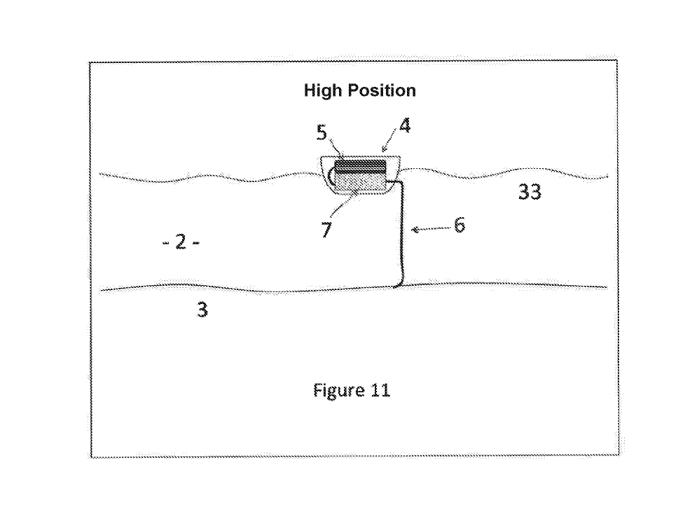

In an advantageous embodiment (FIG. 11), the line (6) is not fully raised back up to its high position, which leaves a portion of suspended cable equal to the maximum suspended portion (Ls). Such embodiment makes it possible to start the production of electricity directly at the nominal power of the system.

In another embodiment, the floating structure, whether stationary or almost stationary, has no mooring ropes since the line(s) play(s) this part, in addition to the part of linear and continuous solid mass(es). In this case, the line(s) 6 is/are not fully raised back up to its/their high position(s) (FIG. 11).

As shown in FIG. 11, the line is stored aboard the floating structure.

In other embodiments, the line can be stored outside the floating structure, using removable floating elements, stored aboard the floating structure or not, and convertible into additional ballast elements of the line or not.

1. A system for storing and producing electrical energy deployed in a volume of water delimited by a bottom, with said system comprising:
a floating structure at the surface of the volume of water,
at least one linear and continuous solid mass connected to the platform and movable between a high position and a low position,
at least one device for driving one or more of such solid mass between the high and low positions thereof;
wherein each one of said masses comprises:
an upper end positioned at the surface of the volume of water
an opposite end which is free or connected to the bottom of the volume of water
a portion lying on the bottom, also called a trailing portion, which is maximum when said mass is in the low position
a suspended portion, which is maximum from the moment that a trailing portion exists,
with said mass configured to take all intermediate positions between the high position and the low position thereof, with such intermediate positions being such that the length of the portion thereof which extends on the bottom is smaller than that of the maximum trailing portion.

2. The system according to claim 1, wherein the floating structure comprises a device for storing, aboard, an upper portion of said mass.

3. The system according to claim 1, wherein the system comprises floating elements for storing, at the surface of the volume of water, an upper portion of said mass.

4. The system according to claim 3, wherein the floating elements are detachably attached to the upper portion of said mass and the floating structure comprises a space for storing such detachable floating elements when such elements are not attached to said mass.

5. The system according to claim 3, wherein each floating element is adapted to be attached to one or more of said masses at the same time.

6. The system according to claim 5, wherein one floating element can be converted into an additional ballast element of said mass, which favors the sinking of said mass.

7. The system according to claim 1, wherein the upper end of said mass is connected to a mooring buoy which keeps said mass at the surface of the volume of water and at a stationary position outside the floating structure.

8. The system according to claim 1, wherein the system comprises several said masses, with the system also comprising means for spacing said masses from one another.

9. The system according to claim 8, wherein the system comprises means for spacing the lower ends of said masses and/or means for spacing the upper ends of said masses liable to form a floating element.

10. The system according to claim 9, wherein the floating structure is motorized according to a predetermined trajectory according to the direction of the electricity exporting cable connected to the floating structure and to the meteocean conditions.

11. The system according to claim 10, wherein the electricity exporting cable is provided with an anchored buoy and in that the trajectory of the floating structure is at least one of a curvilinear and a different shape and is at least one of centered and not centered on the anchor or the anchored buoy of the electricity exporting cable.

12. The system according to claim 1, wherein the floating structure is motorized according to a predetermined trajectory according to the depth of the volume of water to be reached for a given power to be stored or produced.

13. The system according to claim 1, wherein the floating structure is at least one of stationary and almost stationary.

14. The system according to claim 1, wherein the device for driving said mass between the high and low positions thereof comprises a variable and servo-controlled driving speed.

15. The system according to claim 1, wherein said mass consists of at least one of:
a large-sectioned cable
a large-sectioned chain
a cable/chain combination
one of the above three alternative solutions, in addition to which weights are attached along said chain and/or said cable, at regular intervals or irregular intervals, and detachably or attached, with said weights being convertible into floating elements or sinking elements,
any assembly of unit elements specifically adapted to such application.

16. A method for storing and producing electrical energy deployed in a volume of water delimited by a bottom, implemented by the system according to claim 1, comprising:
a phase of energy storing during which said mass is raised back up to the surface from the bottom of the water from a low position to a high position, using the driving device, with at least one of a fixed and a variable driving speed
a phase of energy production during which said mass is lowered at least under the effect of its own weight from a high position to a low position with said fixed or said variable driving speed.
